(19) United States
(12) Patent Application Publication
(10) Pub. No.: US 2005/0092084 A1
(43) Pub. Date: May 5, 2005

(54) Rate sensing device

(76) Inventors: Christopher Paul Fell, Plymouth (GB); Anthony Kevin Rourke, University Park (GB); Stewart McWilliam, University Park (GB)

Correspondence Address: NIXON & VANDERHYE, PC, 1100 N GLEBE ROAD, 8TH FLOOR, ARLINGTON, VA, 22201-4714, US

(21) Appl. No.: 10/490,845

(22) PCT Filed: Feb. 23, 2004
(86) PCT No.: PCT/GB04/00694

(30) Foreign Application Priority Data
Mar. 28, 2003 (GB) 03071966
Mar. 28, 2003 (EP) 032519696

(51) Int. Cl. G01P 9/04

(52) U.S. Cl. 73/504.13

(57) ABSTRACT

A rate sensing device includes a cylindrical vibratory resonator, a hemispherical vibratory resonator or a substantially planar vibratory resonator (1) having a substantially ring or hoop-like shape structure, which resonators have inner and outer peripheries extending around a common axis (2), first carrier mode drive means (18) for causing the resonator (1) to vibrate in a Cos n₁θ carrier mode to provide a first rate sensing channel along the common axis (2), where n₁ has an integer value of 2 or more, and second carrier mode drive means (19) for causing the resonator (1) to vibrate in a Cos n₂θ carrier mode to provide a second rate sensing channel along the common axis (2) where n₂ has an integer value of 2 or more and where n₂ is not equal to n₁, which first and second rate sensing channels are independent of one another and operate over different rate ranges where the rate range increases for higher values of n₁ and n₂.

This invention relates to a rate sensing device particularly, implementable as a vibrating structure gyroscope.

Rate sensing devices such as vibrating structure gyroscopes may be used in a wide range of automotive, commercial and other applications which have different performance requirements in terms of rate range, bias stability and rate output noise. Applications that are limited to low rate ranges will typically have demanding requirements in terms of bias stability and noise performance. Conversely, applications requiring higher rate ranges typically can tolerate a lower level of performance for these parameters. This can be illustrated by comparing the performance requirements for Advanced Braking Systems (ABS) and Adaptive Cruise Control (ACC) in the automotive markets. These applications both require rotation rate measurement capability around the yaw axis of a vehicle. ABS applications typically require a plus or minus 75°/s rate range with a bias stability of less than plus or minus 3°/s and rate output noise of less than 0.5°/s over the operating environment of the instrument. ACC applications require a rate range of less than plus or minus 15°/s with bias stability and noise level requirements correspondingly more stringent.

Achieving a level of performance which satisfies both high and low rate requirements from a single rate sensing device such as a vibrating structure gyroscope is generally not possible. Conventionally these requirements will be met using two different vibrating structure gyroscope sensor designs. For automotive applications, which are particularly cost sensitive, this additional expense may be unacceptable.

There is thus a need for a low cost rate sensing device which is capable of satisfying simultaneously both requirements.

According to a first aspect of the present invention there is provided a rate sensing device including a cylindrical vibratory resonator, a hemispherical vibratory resonator or a substantially planar vibratory resonator having a substantially ring or hoop-like shape structure with inner and outer peripheries extending around a common axis, first carrier mode drive means for causing the resonator to vibrate in a Cos n₁θ carrier mode to provide a first rate sensing channel along the common axis, where n₁ has an integer value of 2 or more, and second carrier mode drive means for causing the resonator to vibrate in a Cos n₂θ carrier mode to provide a second rate sensing channel along the common axis, where n₂ has an integer value of 2 or more and where n₂ is not equal to n₁, which first and second rate sensing channels are independent of one another and operate over different rate ranges where the rate range increases for higher values of n₁ and n₂.

Preferably the first carrier mode drive means and second carrier mode drive means are arranged at any arbitrary relative alignment around the resonator with respect to one another.

Conveniently the first rate sensing channel is also provided with a first carrier mode pick-off means, a first response mode drive means and a first response mode pick-off means, and wherein the second rate sensing channel is provided with a second carrier mode pick-off means, a second response mode drive means, and a second response mode pick-off means.

Advantageously the drive means and pick-off means are located at any radial anti-nodal positions for a given vibration mode.

Preferably the device includes, for each channel, a carrier mode control loop and a response mode control loop.

Conveniently each carrier mode control loop includes an automatic gain control, a voltage controlled oscillator and a phase lock loop, and wherein each response mode control loop includes a quadrature component loop and a real component loop.

In one embodiment n₁=2 and n₂=3.

In the latter embodiment the Cos 2θ carrier mode drive means is positioned relative to the resonator at an angle of 0°, the Cos 2θ carrier mode pick-off means is positioned at 180°, the Cos 2θ response mode motion is detected by the Cos 2θ response mode pick-off means located at 225° and nulled by the Cos 2θ response mode drive means positioned at 45°, the Cos 3θ carrier mode drive means is positioned at 330°, the Cos 3θ carrier mode pick-off means is positioned at 150°, and the Cos 3θ response mode motion is detected by the Cos 3θ response mode pick-off means located at 120° and nulled by the Cos 3θ response mode drive means positioned at 300°.

For a better understanding of the present invention and to show how the same may be carried into effect, reference will now be made, by way of example, to the accompanying drawings in which:

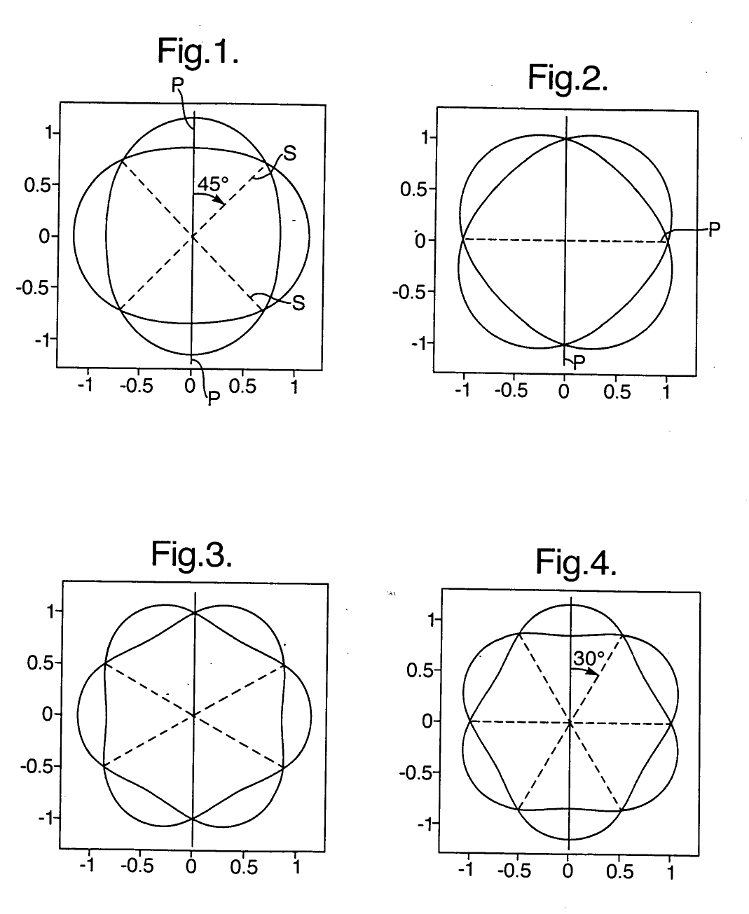

FIGS. 1 and 2 illustrate diagrammatically the vibration modes of a conventional single axis rate sensing gyroscope employing Cos 2θ mode pairs showing primary modes P and secondary modes S,

FIGS. 3 and 4 illustrate diagrammatically vibration modes for a conventional single axis rate sensing device employing a pair of Cos 3θ modes,

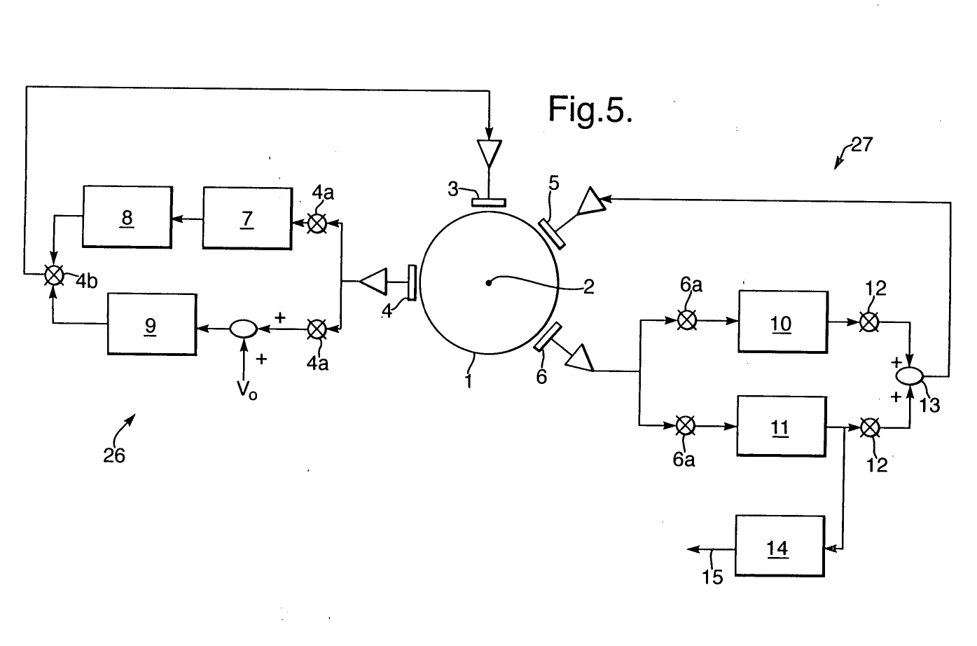

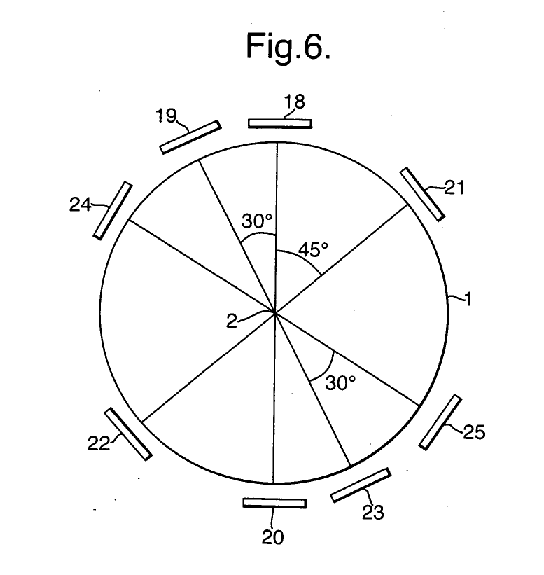

FIG. 5 illustrates diagrammatically the use of conventional control loops for controlling the operation of a conventional rate sensing device such as a vibrating structure gyroscope, and

FIG. 6 illustrates schematically the relationship of drive and pick-off means for a rate sensing device according to one embodiment of the present invention.

Rate sensing devices in the form of vibrating structure gyroscopes can take many forms such as having a cylindrical vibratory resonator, a hemispherical vibratory resonator or a substantially planar vibratory resonator. Although the present invention is applicable to all these exemplars it will be described herein for convenience in terms of application to a device having a substantially planar vibratory resonator.

Referring now to the accompanying drawings FIGS. 1 and 2 show vibration modes for a conventional single axis rate vibrating structure gyroscope having a vibrating planar ring structure such as described in GB 2322196. Such conventional devices employ Cos 2θ mode pairs as illustrated in FIGS. 1 and 2. It is also possible to fabricate conventional devices using higher order Cos nθ mode pairs in a similar fashion using a pair of Cos 3θ modes as shown in FIGS. 3 and 4.

Conventional devices employing either Cos 2θ or Cos 3θ mode pairs operate in a very similar manner. One of these modes is excited as the carrier mode with the complementary mode operating as the response mode. For the device described in GB 2322196 the carrier mode is as shown in FIG. 1 with the response mode as shown in FIG. 2. For a device using a pair of Cos 3θ modes the carrier mode is shown in FIG. 3 and the response mode is shown in FIG. 4.

A conventional rate sensing device in the form of a vibrating structure gyroscope and a rate sensing device according to the present invention both include a substantially planar vibratory resonator generally indicated at 1 in FIGS. 5 and 6 of the accompanying drawings having a substantially ring or hoop-like shape structure with inner and outer peripheries extending around a common axis 2. When the device is rotated around the common axis 2 normal to the plane of the ring of the resonator 1 Coriolis forces F, are developed which couple energy into the response mode. The magnitude of the force is given by:
F_{c}=2mvΩₐₚₚ (1)
where m is the modal mass, v is the effective velocity and Ωₐₚₚ is the applied rotation rate. The carrier mode vibration amplitude is typically maintained at a fixed level. This also maintains the velocity, v, at a fixed level and hence ensures that the developed Coriolis forces are directly proportional to the rotation rate Ωₐₚₚ. The amplitude of response mode motion induced by these Coriolis forces may be enhanced by accurately matching the resonant frequencies of the carrier and response modes. The motion is then amplified by the Q of the response mode giving enhanced device sensitivity. When operating in this open loop mode the sensitivity (scalefactor) of the device will be dependent on the Q of the response mode, which may vary significantly over the operating temperature range. This dependence may be eliminated by operating the device in a force feedback (closed loop) mode. In this mode the induced response mode motion is actively nulled with the applied force now being directly proportional to the rotation rate.

Conventional rate sensing devices such as a vibrating structure gyroscope usually require carrier mode drive means 3, carrier mode pick-off means 4, response mode drive means 5 and response mode pick-off means 6 as shown in FIG. 5 of the accompanying drawings. Such conventional devices can be controlled conventionally using a closed loop operation with control loops as shown in FIG. 5. A carrier pick-off signal received from the carrier mode pick-off means 4 is demodulated at 4a prior to application to carrier loops and re-modulated at 4b before application to the carrier drive means 3. A phase locked loop 7 compares the relative phases of the carrier pick-off signal and the carrier drive signal and adjusts a voltage controlled oscillator 8 frequency to maintain a 90° phase shift between the applied drive and the resonator motion. This maintains the motion at the resonance maximum.

The carrier mode pick-off signal taken from the means 4 is also applied to an automatic gain control loop 9 which compares the carrier mode pick-off signal level to a fixed reference level V_{O}. The signal level supplied to the carrier drive means 3 is adjusted in order to maintain a fixed signal level, and hence amplitude of motion, at the carrier mode pick-off means 4.

The response mode pick-off signal received by the means 6 is demodulated at 6a to separate real and quadrature components of the rate induced motion. The real component is that which is in-phase with the carrier mode motion. The quadrature component is an error term which arises due to the mode frequencies not being precisely matched. Loop filtering is applied to these demodulated baseband (DC) signals at a quadrature loop 10 and at a real loop 11 to achieve the required system performance of bandwidth, noise etc. The resultant signals are then remodulated at remodulators 12 and summed at a summer 13 for application to the response mode drive means 5 in order to maintain a null at the response mode pick-off means 6. The real baseband signal, RD (real) which is directly proportional to the real response drive applied to the resonator 1 is scaled and filtered at a filter 14 to produce a rate output signal 15.

In practical systems the maximum available nulling force which may be applied to null the response mode motion will be approximately equal to the maximum drive force available for driving the carrier mode. Beyond this drive level the response drive means 5 is no longer able to null the induced motion. This is the factor which limits the maximum operating rate range of the device.

The response drive level (RD) for a rotation rate Ω_{R} is given by:

$$RD = 2 {G}_{n} \frac{Q}{ω} \cdot CD . {Ω}_{R} \qquad ( 2 )$$

where CD is the carrier mode drive level (proportional to amplitude of motion), ω is the resonance frequency of the mode of order n and Gₙ is the Bryan Factor which is a constant defining the modal coupling.
The maximum operating rate range (i.e. RD=CD) is therefore given by:

$${Ω}_{MAX} = \frac{ω}{2 {G}_{n} \cdot Q} \qquad ( 3 )$$

For a simple ring structure resonator with no support legs the Gₙ factor is given by the formula:

$${G}_{n} = 1 - \frac{2 n}{( {n}^{2} + 1 )} \qquad ( 4 )$$

where n is the mode order which gives:

| n | Gₙ |
|---|---|
| 2 | 0.8 |
| 3 | 0.6 |
| 4 | ˜0.47 |

For practical resonators incorporating support leg structures these values will be slightly modified (reduced).

In order to increase the operating rate range it is therefore desirable to increase ω and reduce Q. Using a higher order mode will also increase the rate range due to the reduction in Gₙ. Conversely, in order to increase the sensitivity it is desirable to reduce ω and maximise Q and to utilise the lowest order n=2 mode. The noise performance of vibrating structure gyroscope sensors is typically determined by the input noise of the response mode preamplifier. Increasing the sensitivity (i.e. increasing the input signal level for a given applied rate) will therefore reduce the rate equivalent noise level. Optimising the sensitivity in this manner also has the advantage of reducing the bias errors (spurious rate output in the absence of rotation) of the instrument. Those skilled in the art will understand that many of the error terms contributing to the overall bias scale in direct proportion to (ω/2Gₙ.Q).

A conventional planar ring resonator 1 of a device such as described in GB 2322196 typically has a Cos 2θ resonance mode frequency of ˜14 kHz and typically is operated with a Q value of ˜5000. Substituting these values into equation 2, together with the appropriate Bryan factor, gives a maximum operating rate range of ˜630°/s. The Cos 3θ resonance mode frequency is ˜31 kHz and has a similar Q value. This gives a maximum operating rate range of ˜1860°/s. Use of higher order modes will give correspondingly a higher maximum operating rate range. If achieving the optimum bias stability and noise performance is of paramount importance then it is preferable to operate the resonator using the Cos 2θ modes. However, if high rate range capability is required then it is more advantageous to operate the device using the Cos 3θ or higher order modes.

A rate sensing device of the present invention which preferably is in the form of a vibrating structure gyroscope having the substantially planar vibrating resonator 1 with a substantially ring or hoop-like shape structure with inner and outer peripheries extending around the common axis 2 makes it possible to operate the device using two different modes pairs simultaneously. To this end a device of the present invention includes first carrier mode drive means 18 for causing the resonator 1 to vibrate in a Cos n₁θ carrier mode to provide a first rate sensing channel along the common axis 2, where n₁ has an integer value of two or more. The device also includes second carrier mode drive means 19 for causing the resonator 1 to vibrate in a Cos n₂θ carrier mode to provide a second rate sensing channel along the common axis 2, where n₂ has an integer value of 2 or more and where n₂ is not equal to n₁. The first and second rate sensing channels are independent of one another and operate over different rate ranges where the rate range increases for higher values of n₁ and n₂. The first carrier mode drive means 18 and the second carrier mode drive means 19 are arranged at any arbitrary relative displacement around the resonator 1 with respect to one another with the vibration modes behaving independently with the displacement around the ring resonator 1 being given by a linear combination of the individual mode displacements.

The first rate sensing channel of the device of the present invention is also provided with a first carrier mode pick-off means 20, a first response mode drive means 21 and a first response mode pick-off means 22. Similarly the second rate sensing channel is provided with a second carrier mode pick-off means 23, a second response mode drive means 24 and a second response mode pick-off means 25, all of which are shown in FIG. 6 of the accompanying drawings. The drive means and pick-off means are located at any convenient radial anti-nodal position for a given vibration mode.

Thus with a rate sensing device according to the present invention the first and second rate sensing channels operate as individual single axis rate sensing devices. The individual channels provide independent rotation rate information precisely aligned along the common axis 2. Each channel is controlled using independent control loops identical to those illustrated in FIG. 5 of the accompanying drawings and herein before described in terms of use for a conventional single axis rate sensing device in the form of a vibrating structure gyroscope, operating at the appropriate resonance mode frequency. Thus each channel is provided with a carrier mode control loop 26 and a response mode control loop 27. In basic terms each carrier mode control loop includes the automatic gain control loop 9, the voltage control oscillator 8 and the phase lock loop 7 and each response mode control loop 27 includes the quadrature component loop 10 and the real component loop 11.

In the example of the invention as illustrated in FIG. 6 of the accompanying drawings n₁=2 and n₂=3 providing both Cos 2θ and Cos 3θ mode pairs simultaneously.

In order to implement this dual mode operation it is necessary to provide drive and pick-off transducer means elements at appropriate angular locations around the ring to enable the Cos 2θ and Cos 3θ mode pairs to be independently excited and the induced motion to be detected. A suitable arrangement is shown schematically in FIG. 6. The Cos 2θ carrier mode drive is positioned at an angle of 0° with the cos 2θ carrier mode pick-off at 180°. The Cos 2θ response mode motion is detected by the Cos 2θ response mode pick-off located at 225° and nulled by the Cos 2θ response mode drive at 45°. The Cos 3θ carrier mode drive is positioned at an angle of 330° with the Cos 3θ carrier mode pick-off at 150°. The Cos 3θ response mode motion is detected by the Cos 3θ response mode pick-off located at 120° and nulled by the Cos 3θ response mode drive at 300°.

Those skilled in the art will realise that other arrangements may also be used without altering the basic functionality of the device. Drive and pick-off transducer elements may be located at any anti-nodal position for a given vibration mode. Also, as the Cos 2θ and Cos 3θ channels operate independently, the relative angular alignment between them may also be varied without changing the basic functionality. The configuration shown in FIG. 6, which has the Cos 3θ modes at an angular alignment of −30° with respect to the Cos 2θ modes, represents only one possible implementation.

As the Cos 2θ and Cos 3θ vibration modes are oscillating simultaneously, the pick-off outputs will generally be made up of signal components at both frequencies. The relative contributions of the Cos 2θ and Cos 3θ components will depend on the precise angular location of the respective response mode pick-offs and the relative angular alignment between the Cos 2θ and Cos 3θ vibration modes. As the two resonance frequencies are well separated, filtering may be applied which enables the required signal component to be isolated and accurately demodulated for application to the control loops.

This dual mode capability may also be implemented using other mode combinations with an appropriate arrangement of drive and pick-off transducers. Those skilled in the art will appreciate that it is also possible to utilise the Cos 2θ and Cos 4θ vibration mode pairs (where n₁=2 and n₂=4) which would give a larger difference between the respective operating rate ranges. The Cos 3θ and Cos 4θ vibration modes (where n₁=3 and n₂=4) or any other mode combination may also be employed to the same effect.

This dual mode of operation has additional advantages beyond the ability to provide rate outputs optimised for different applied rate ranges. The use of two independent rate measurement channels can provide a high degree of built in test (BIT) coverage. The output of the two channels can be directly compared and should give identical measurements of the applied rotation rate, within the error limits of the instrument. Any discrepancy will indicate a failure within the control electronics or transducers of one of the channels. The availability of the second channel would also provide for a degree of redundancy to allow the instrument to continue to function after such a failure.

Many of the error mechanisms, which determine the overall bias and scalefactor accuracy, behave independently for the individual channels. These include errors associated with transducer alignments and gains, frequency split and mode alignment. It is therefore advantageous to average the two independent rotation rate measurements to obtain improved overall accuracy from the device.

A further advantage of the present invention is that the rate sensing axes of the two channels will be in exact alignment without the requirement for any precise mechanical assembly process such as would be required when using two separate instruments. This is due to the fact that the two rate channels utilise the same sensing element.

1. A rate sensing device including a cylindrical vibratory resonator, a hemispherical vibratory resonator or a substantially planar vibratory resonator having a substantially ring or hoop-like shape structure, which resonators have inner and outer peripheries extending around a common axis, first carrier mode drive means for causing the resonator to vibrate in a Cos n₁θ carrier mode to provide a first rate sensing channel along the common axis, where n, has an integer value of 2 or more, and second carrier mode drive means for causing the resonator to vibrate in a Cos n₂θ carrier mode to provide a second rate sensing channel along the common axis, where n₂ has an integer value of 2 or more and where n₂ is not equal to n₁, which first and second rate sensing channels are independent of one another and operate over different rate ranges where the rate range increases for higher values of n₁ and n₂.

2. A device according to claim 1, in which the first carrier mode drive means and second carrier mode drive means are arranged at any arbitrary relative alignment around the resonator with respect to one another.

3. Device according to claim 1, wherein the first rate sensing channel is also provided with a first carrier mode pick-off means, a first response mode drive means and a first response mode pick-off means, and wherein the second rate sensing channel is provided with a second carrier mode pick-off means, a second response mode drive means, and a second response mode pick-off means.

4. A device according to claim 3, wherein the drive means and pick-off means are located at any radial anti-nodal position for a given vibration mode.

5. A device according to claim 3, including for each channel a carrier mode control loop and a response mode control loop.

6. A device according to claim 5, wherein each carrier mode control loop includes an Automatic Gain Control, a Voltage Controlled Oscillator and a Phase Lock Loop and wherein each response mode control loop includes a quadrature component loop and a real component loop.

7. A device according to claim 3, in which n₁=2 and n₂=3.

8. A device according to claim 7, in which the Cos 2θ carrier mode drive means is positioned relative to the resonator at an angle of 0°, the Cos 2θ carrier mode pick-off means is positioned at 180°, the Cos 2θ response mode motion is detected by the Cos 2θ response mode pick-off means located at 225° and nulled by the Cos 2θ response mode drive means positioned at 45°, the Cos 3θ carrier mode drive means is positioned at 330°, the Cos 3θ carrier mode pick-off means is positioned at 150°, and the Cos 3θ response mode motion is detected by the Cos 3θ response mode pick-off means located at 120° and nulled by the Cos 3θ response mode drive means positioned at 300°.

9. (canceled).
